(19) United States
(12) Patent Application Publication
(10) Pub. No.: US 2017/0131710 A1
(43) Pub. Date: May 11, 2017

(54) METHOD AND SYSTEM FOR MACHINE TOOL HEALTH EARLY WARNING MONITORING

(71) Applicant: Caterpillar Inc., Peoria, IL (US)

(72) Inventors: Yujie Chen, Peoria, IL (US); George Koruthu Mathai, Peoria, IL (US); Thomas Michael Garland, East Peoria, IL (US); Gerald Thomas Otten, Washington, IL (US); Cary John Lyons, Morton, IL (US); Thimmaiah Kumbera Ganapathi, Peoria, IL (US)

(21) Appl. No.: 15/335,170

(22) Filed: Oct. 26, 2016

Related U.S. Application Data
(60) Provisional application No. 62/246,391, filed on Oct. 26, 2015.

(51) Int. Cl. G05B 23/02; G06Q 10/00

(52) U.S. Cl. CPC G05B 23/0283; G06Q 10/20; G05B 23/0267

(57) ABSTRACT

A system for monitoring machine tool health is disclosed. The system includes a machine tool and a central data server configured to receive, process, and send data. A plurality of sensors are associated with the machine tool, and the sensors are configured to measure operating parameters of the machine tool that relate to potential failure of a machine tool component. The sensors also are configured to send data relative to the measured operating parameters to the central data server. A system for enterprise resource planning is configured to receive data from the central data server, analyze the received data to determine whether preventive maintenance is indicated for the machine tool, and schedule preventive maintenance for the machine tool.

### RELATED APPLICATIONS

This application is based upon and claims priority from U.S. Provisional Application No. 62/246,391 by Yujie Chen et al., filed Oct. 26, 2015, the contents of which are expressly incorporated herein by reference.

### TECHNICAL FIELD

The present disclosure is directed to machine tool health and, more particularly, is directed to a method and system for machine tool health early warning monitoring.

### BACKGROUND

Machine tools may be employed in various manufacturing processes, such as the manufacture of other machines. For example, machine tools may be used for machining operations such as milling, cutting, boring, grinding, shearing, and other types of mechanical deformation and/or material removal in forming the various components of other machines such as engines, excavating machines, haulage machines, etc. A machine component that is to be manufactured may require but a single milling machine to shape a workpiece into a desired component in its final form. Typically, however, a machine component may require several operations by one or more machine tools in order to reach the desired final form. A workpiece may, for example, be milled by a first machine tool, have holes drilled by a second machine tool, receive an additional milling operation by a third machine tool, and then have the holes provided with threads by a fourth machine tool. In other words, a part to be manufactured may require one or more operations by one or more machine tools.

It is inevitable that events such as unexpected spindle mechanism and/or table system failures, coolant issues, overheated components, and severe tool wear will occur sooner or later. When these events occur unexpectedly, the result may be additional costs and time delays incurred by the necessity for rework, machine down time, and substantial operator attention. Machine tool health is a key manufacturing productivity driver, especially in the machining of large structures, such as those required for mining and excavating machines, for example. This is particularly true where parts are being manufactured in assembly line fashion by being moved from one machine tool to a subsequent machine tool in order to receive different types of material removal and/or forming operations. If one machine tool fails in a production line where multiple steps are involved in component part production, the production line may be shut down for a lengthy and costly period of time while the machine tool is repaired or an alternative machine is put in place.

There exists a need for an optimized and proactive preventive maintenance system for machine tools. It would be both beneficial and desirable to implement such a system so as to increase productivity and enable planned lead time achievement in maintaining machine tools. In other words, it would be both beneficial and desirable to conduct preventative maintenance on machine tools in such a way as to avoid failure of machine tool components and/or systems or a decrease in quality and productivity of the work product. It would be both beneficial and desirable to know when a machine tool will be down for maintenance with enough lead time to ensure substitution into a production line of an alternative machine during maintenance, and to ensure enough lead time to order and have on hand necessary maintenance parts “just in time” and without the need for storing an inventory of spare parts.

One type of system and method for monitoring the health of a machine tool is disclosed in U.S. Pat. No. 7,571,002 that issued on Aug. 4, 2009, to Jalluri et al. (the '002 patent). The '002 patent discloses a method and system based on the premise that the health of the machine tool itself, rather than a particular machining process, may best be determined by operating the machine tool “outside an operation cycle.” According to the disclosure of the '002 patent, a machine operation parameter, such as vibrations, current, temperature, torque, or speed for the machine tool, is sensed during an analysis program while the machine tool is operated outside an operation cycle. Data from sensor output signals is processed to define a number of movement specific data profiles. An algorithm is applied to the data profiles in order to generate movement-specific data points. Once these movement-specific data points have been generated, they may be combined with data points gathered at different times when the analysis program is run. A trend line can then be plotted and an alarm can be applied to the trend line to indicate to an operator that certain components are becoming worn.

While the method and system of the '002 patent may enable machine health to be monitored to some extent, it has a number of disadvantages. The disclosure of the '002 patent is limited to analysis of component operating parameters when the machine tool is operating, but not while it is operating on and processing a workpiece. The analysis program must be run repeatedly off-line in order to generate enough data for a trend line. This may not provide an accurate indication of machine tool health since it does not collect data while the machine tool is actually processing a workpiece. In addition, it does not provide a machine tool health early warning monitoring system that integrates hardware, algorithms, and sensor outputs for spindle mechanism and/or table system vibration, machine coolant parameters, component lubrication, and tool wear to provide a resource planning system based on the health of each machine tool of a production line of machine tools.

The method and system for machine tool health early warning monitoring of the present disclosure solves one or more of the problems set forth above and/or other problems of the prior art.

### SUMMARY

In one aspect, the present disclosure is directed to a system for monitoring machine tool health. The system may include a machine tool and a central data server configured to receive, process, and send data. The system also may include a plurality of sensors associated with the machine tool, wherein the sensors are configured to measure operating parameters of the machine tool that relate to potential failure of a machine tool component, and configured to send data relative to the measured operating parameters to the central data server. The system also may include a system for enterprise resource planning configured to receive data from the central data server, analyze the received data to determine whether preventive maintenance is indicated for the machine tool, and schedule preventive maintenance for the machine tool.

In another aspect, the present disclosure is directed to a method of monitoring machine tool health. The method may include initially operating the machine tool at a desired performance level. The method also may include sensing operating parameters that are indicative of potential failure or less than the desired machine tool performance level for a plurality of components of the machine tool while the machine tool is machining a workpiece. The method also may include generating data from sensing the operating parameters. The method also may include communicating the data to a central data server, processing the data, and sending the processed data to a system for enterprise resource planning. The method also may include scheduling preventative maintenance for the machine tool, based on the processed data.

In yet another aspect, the present disclosure is directed to an early warning system for the health of a plurality of machine tools. The system includes a plurality of machine tools configured to perform sequential machining operations on a workpiece. The system also includes at least one first sensor for sensing vibration in a spindle mechanism and table system for each of the plurality of machine tools. The system also includes at least one second sensor for sensing a condition of a coolant for a work tool of each of the plurality of machine tools. The system also includes at least one third sensor for sensing temperature of a machine component of each of the plurality of machine tools. The system also includes at least one fourth sensor for sensing tool wear in each of the plurality of machine tools. The system also includes a central data server for receiving sensor data from each of the first, second, third, and fourth sensors of each of the plurality of machine tools, processing the received sensor data, and sending processed data via at least one of an email early warning alert and a text message early warning alert. The system also includes a remote viewing station configured to permit viewing of data processed by the central data server. The system further includes a system for enterprise resource planning configured to receive processed data from the central data server and schedule preventive maintenance for one or more of the plurality of machine tools based on the received processed data, and schedule one or more alternative machine tools to substitute for the one or more of the plurality of machine tools during preventive maintenance.

### BRIEF DESCRIPTION OF THE DRAWINGS

FIG. 1 is a schematic diagram of a system for machine tool health early warning monitoring;

FIG. 2 is a schematic diagram of a sensor system for machine tool health monitoring;

FIG. 3 is a flow diagram of an exemplary disclosed method; and

FIG. 4 is a graphical representation of desirable preventive machine tool maintenance.

### DETAILED DESCRIPTION

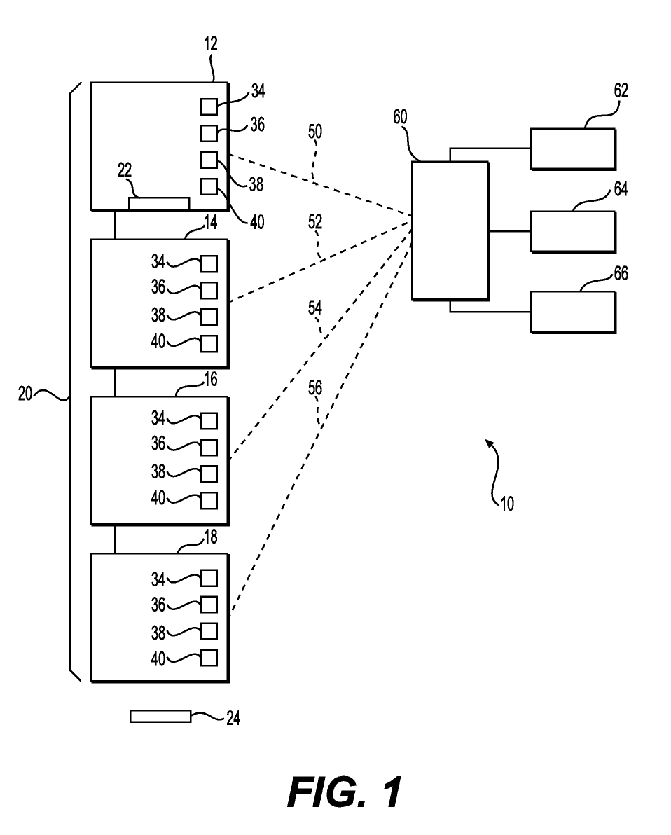

A system 10 for machine tool health early warning monitoring is schematically illustrated in FIG. 1. System 10 may include multiple machine tools 12, 14, 16, and 18 in a production line 20. Machine tools 12, 14, 16, 18 may be, for example, computer numerical control (CNC) machine tools. Production line 20 may be employed in the manufacture of any number of various parts that may be components of other parts and/or ultimately may be used in the manufacture of other machines. A component to be manufactured may be placed in production line 20 as a workpiece 22, illustrated diagrammatically on machine 12, that may be formed, either partially or entirely, by machine tools 12, 14, 16, 18 of production line 20. As each machine tool performs its designated work on workpiece 22, workpiece 22 may be advanced to the next machine in order to receive additional processing until workpiece 22 has been formed into the intended part 24, diagrammatically illustrated next to machine tool 18. In other words, referring to FIG. 1, a workpiece 22 may be advanced sequentially from machine tool 12 to machine tool 14, then to machine tool 16, and finally to machine tool 18 to form part 24.

As an example of a somewhat typical production line 20, machine tool 12 may be a milling machine that may mill workpiece 22 to have a flat, smooth surface. Once machine tool 12 has finished its designated milling operation, workpiece 22 may be advanced to machine tool 14. Machine tool 14 may be a drilling machine designated to drill one or more holes in workpiece 22. Following the drilling process by machine tool 14, workpiece 22 may be advanced to machine tool 16, which may be another milling machine designated to mill another surface of workpiece 22. After machine tool 16 has finished its work, workpiece 22 may then be advanced to machine tool 18, which may be a machine tool designated to form threads in the holes that were drilled by machine tool 14. The final result may be the intended part 24. This is one example of production line 20 and machine tools 12, 14, 16, 18. It is contemplated that the number of machine tools in a production line 20 and the types of work that each may perform may vary greatly, depending upon the particular workpiece/part that is to be processed and manufactured.

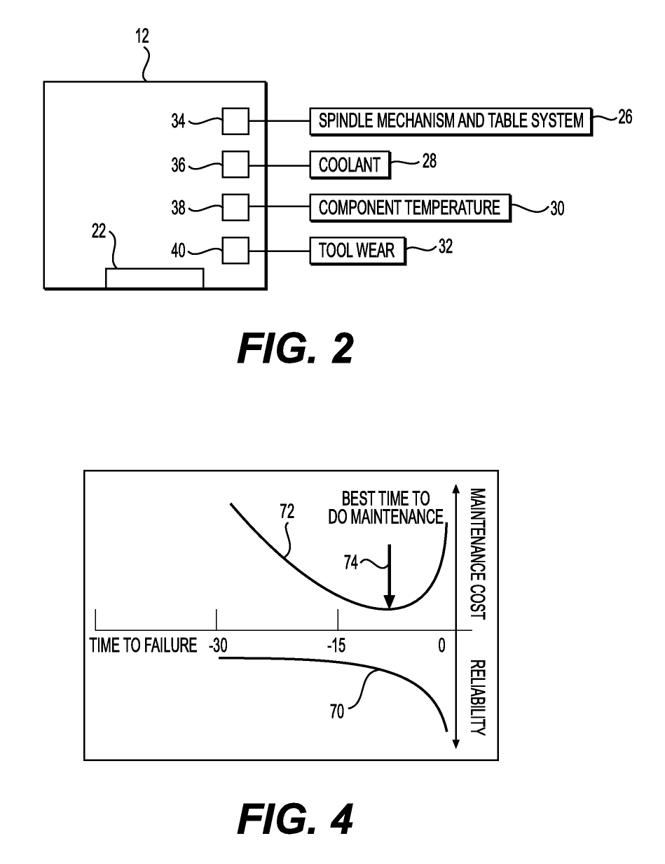

In general, a machine tool 12, 14, 16, 18 may include a number of components that require periodic maintenance in order for the machine tool to perform at its desired level. FIG. 2 diagrammatically illustrates machine tool 12 of FIG. 1 and certain components, systems, and conditions that typically are a part of, relevant to, and/or associated with machine tools in general. Referring to FIG. 2, a milling or cutting bit of machine tool 12 typically may be driven to perform its work via a spindle mechanism and table system 26 as is well known in the art. As components of the spindle mechanism and table system 26 begins to wear, either or both of the spindle mechanism and table system may be subject to vibrations. Such vibrations, where nominal, may not require immediate attention. However, over time, such vibrations may lead to wear, and this may in turn lead to a decrease in performance and/or failure of one or both of the spindle mechanism and table system 26. Accordingly, spindle mechanism and table system 26 is one component of typical machine tool 12 that should receive periodic preventative maintenance.

Machine tools also employ coolant, indicated as coolant 28 in FIG. 2, that is used to keep the work tool (e.g., milling bit, drill bit, etc.) from overheating. In order to avoid oxidation/rust of the work tool, coolant 28, typically forced as a stream of fluid onto the work tool during machine tool operation on a workpiece, should be maintained at a relatively neutral pH of about 7 and with a consistent concentration of various additives that are intended to enhance the flow, cooling effect, and stabilization of coolant 28. Also, an appropriate coolant level must be maintained to ensure that coolant 28 will reliably be available and supplied during machining operations.

A machine tool table system that supports workpiece 22 may include conventional drive motors, gearing, bearing surfaces, ball screw mechanisms, and guides (not illustrated) to accommodate relative movement of the table along x, y, and/or z axes. Also, spindle bearings may be present to enable spindle rotation with minimal friction. All of these components, as well as other moving components of machine tool 12, may require carefully controlled lubrication in order to avoid overheating and wear, and less than desired performance. Accordingly, component temperature 30 may require careful monitoring, since temperature is a reliable indicator for proper lubrication.

The work tool employed in a machine tool, such as machine tool 12, may be subject to tool wear 32. A worn work tool may place stress on other machine components, as well as generate a work product that may not conform to specified tolerances and other quality considerations. It is desirable that appropriate personnel know when a work tool is beginning to show wear so that it can be replaced at a time that is convenient to maintaining production and before it results in a decrease in work product quality.

Referring both to FIG. 1 and FIG. 2, machine tools 12, 14, 16, 18 of system 10 may include sensors designed and configured to monitor at least the components, systems, and conditions discussed above in connection with FIG. 2. It is contemplated that other components, systems, and conditions also may be monitored. Machine tool 12 may include a sensor 34 configured to sense vibrations in spindle mechanism and table system 26. It is contemplated that the term “sensor” as used in this disclosure may include either a single sensor or multiple sensors since it may be beneficial on some machine tools to include multiple sensors for adequately monitoring components, systems, and/or conditions. Spindle mechanism and table system 26 includes both the spindle mechanism that drives the tool, and the table system that moves the workpiece in at least x and y directions. Accordingly, sensor 34, while designated singular to simplify description, may in fact be plural, constituting multiple sensors that separately detect and/or measure vibrations in the spindle mechanism and in various table system components such as slides, linear servos, and/or ball screws, for example. Sensor 34 may be any of myriad conventional vibration sensors such as wireless or wired sensors of the piezoresistive accelerometer configuration, for example. Sensor 34 may be connected to spindle mechanism and table system 26 so as to detect and monitor vibrations and communicate sensed data either wirelessly or via communication line 50 to central data server (CDS) 60, as shown in FIG. 1.

Machine tool 12 also may include a sensor 36 (or a plurality of sensors) configured to sense and monitor machine tool coolant 28 used to cool the work tool. Since a number of coolant parameters are relevant to proper machine tool performance, sensor 36 is indicated as representative of sensing and monitoring coolant parameters. In fact, sensor 36 may be a plurality of diverse, conventional sensors configured to measure parameters such as coolant pH, coolant concentration (e.g., the concentration of coolant additives), and the level of coolant available. Sensor 36 may generate data and communicate that data to central data server 60 via communication line 50, for example, as shown in FIG. 1.

Machine tool 12 also may include one or more sensors 38 configured to sense component temperature 30. A number of machine tool components may advantageously be equipped with a sensor 38. Typically, components that may require lubrication, such as spindle bearings, may be provided with a sensor 38. Sensor 38 may be any of various conventional sensors capable of accurately detecting and monitoring temperature such as, for example, thermistors and thermocouples. Sensor 38 may communicate data to central data server 60 via communication line 50 of system 10, as shown in FIG. 1. Sensing the temperature of a machine tool component may give an indication of the lubrication status of the component.

Machine tool 12 also may include a sensor 40 configured to detect and monitor tool wear. Sensor 40 may be any conventional sensor that is capable of determining changes in character of a work tool that are indicative of wear. For example, Hall effect sensors and/or acoustic emission (AE) sensors advantageously may be employed to sense changes in character of a work tool of machine tool 12 indicative of tool wear. Sensor 40 may communicate data to central data server 60 via communication line 50, as shown in FIG. 1.

Each of additional machine tools 14, 16, and 18 also may include sensors 34, 36, 38, and 40, configured and arranged in a manner similar to the configuration and arrangement for machine tool 12. Data from sensors 34, 36, 38, 40 for each of additional machine tools 14, 16, and 18 may be communicated to central data server 60 via communication lines 52, 54, 56, respectively. It is contemplated that the various machine tools in a production line 20 may be supplied either with fewer or with more sensors, depending on the machine tool involved and the particular operation it is designed to perform. Regardless of the number of sensors provided in a machine tool and/or the number of machine tools in a production line 20, data acquired by sensors 34, 36, 38, 40 may be accumulated and stored in central data server 60.

Still referring to FIG. 1, central data server 60 of system 10 may communicate directly with each of machine tools 12, 14, 16, 18. Central data server 60 may include both memory storage and a processor, and may include capabilities of receiving, storing, processing, and sending data. Machine tools 12, 14, 16, 18 may communicate not only with central data server 60, but also with one another. For example, where machine tool 12 is a milling machine, and sensors detect a minor discrepancy that is insufficient to require maintenance but consequential for optimum quality (e.g., 10 microns off specifications where tolerances permit a somewhat greater deviation), this minor discrepancy may be communicated to one or more subsequent machine tools in production line 20 which may then compensate for the minor discrepancy in subsequent processing.

Central data server 60 may communicate with appropriate personnel via email or text messaging, for example, to send appropriate alerts 62 relating to sensor data and/or maintenance information. Remote viewing 64 also may be available in order for appropriate personnel to be able to view data relevant to machine tools in production line 20. In addition, central data server 60 may communicate with a system of enterprise resource planning (ERP) 66 in order to convey data to ERP 66 and in order to receive information relevant to maintenance planning and scheduling. Either or both of central data server 60 and ERP 66 may process sensor data via algorithms compatible with the particular sensor involved.

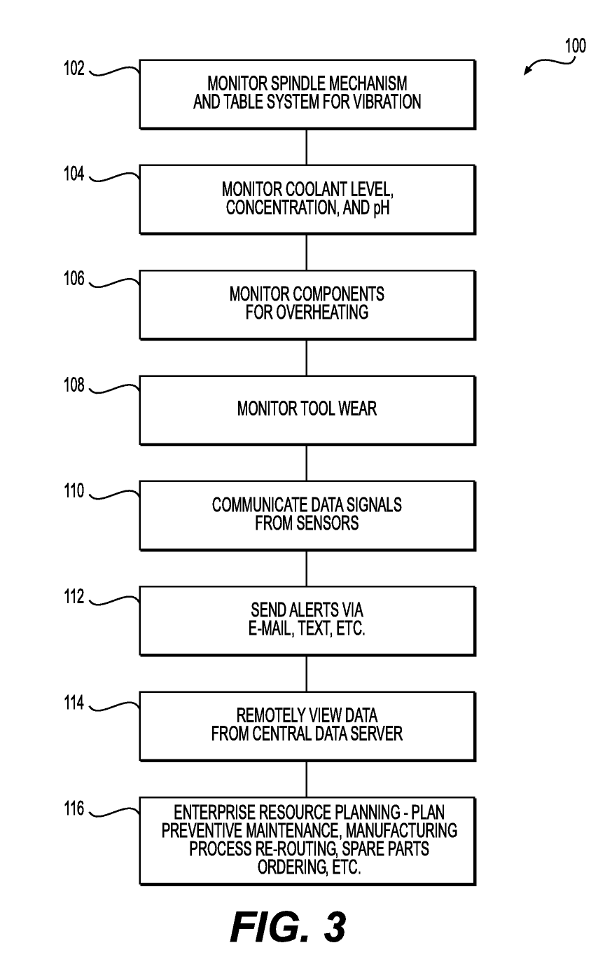

FIG. 3 is a flow diagram 100 illustrating an exemplary process for monitoring machine tool health and providing early warning. The exemplary process in flow diagram 100 may apply either to a single machine tool, or it may apply to a plurality of machine tools such as a production line wherein a workpiece to be machined may progress from one machine tool to another to receive successive operations in developing a work product. Initially, a machine tool may be operating at its desired performance level. As operation proceeds, several machine tool maintenance items may be monitored in order to assess machine tool health and provide early warning. Monitoring may include providing sensors to sense various components, parameters, and conditions of the machine tool, or of a plurality of machine tools in the case of a production line.

The conventional spindle mechanism and table system employed in machine tools to drive a work tool and manipulate a workpiece may be monitored for vibration at step 102. This may be implemented by employing one or more suitable vibration sensors associated with the spindle mechanism and/or the table system. Components of the table system that may sometimes operate at less than optimum due to vibration, include, slides, linear servos, and ball screws, for example. These components, and other table system components, along with the spindle mechanism, may be monitored for vibration.

For coolant used to cool a work tool for a machine tool, coolant level, concentration, and pH may be monitored via suitable sensors at step 104. Components subject to overheating, such as spindle bearings, for example, may be monitored at step 106. This may be accomplished by monitoring their temperature status via thermocouples or other temperature sensors in order to determine their lubrication status. Tool wear may be monitored at step 108 via Hall effect sensors and/or acoustic emission (AE) sensors, for example.

As machine tool operation proceeds, the various sensors may generate data from sensing the various operating parameters. Information/data signals from sensors employed at steps 102-108 may be communicated at step 110 to a central data server where the data may be processed. From the central data server, alerts may be sent to various personnel via email, text messaging, etc., at step 112. At step 114, remote viewing by appropriate personnel of data accumulated in central data server may be provided. Also from the central data server, data may be sent to a system for enterprise resource planning (ERP). Based on the processed data, at step 116 ERP may be used to schedule machine downtime, plan preventive maintenance and necessary resources for the preventative maintenance, and take steps to avoid lost productivity. The manufacturing process may be re-routed so that an alternate machine tool may substitute for the machine tool receiving maintenance, and spare parts for the maintenance may be ordered so as to be on hand when the maintenance is to occur.

For example, sensor data may indicate that a particular machine tool component or system requires maintenance. Maintenance may be scheduled and it may then be known that the machine tool will be down in two weeks, and that it will take approximately ten hours to perform the required maintenance. Through ERP, an alternate machine tool may be made ready to substitute for the machine tool that will be down, and the alternate machine tool may be scheduled for at least the period of time that the machine tool being maintained will be down. As a result, production loss may be avoided. Concurrently, part ordering delays may be taken into account. Where it is known that a machine tool will be down in two weeks, necessary maintenance parts may be ordered with sufficient lead time so that they are available when maintenance is to occur. The necessity for parts inventory may substantially be eliminated by such “just in time” arrival of necessary parts. The expense of maintaining an inventory of spare parts may effectively be avoided.

It should be understood that flow diagram 100 illustrates one exemplary method that may be performed in accordance with this disclosure. It is contemplated that less than the four indicated categories of items (at steps 102-108) may be monitored, or that additional categories of items may be monitored. In addition, alerts (step 112) may be included but remote viewing (step 114) eliminated in certain situations, and remote viewing may be included with alerts eliminated in certain other situations. It also is contemplated that the steps indicated in flow diagram 100 may not necessarily be sequential.

FIG. 4 graphically illustrates a desired result from a system of enterprise resource planning 66. Time is indicated along the abscissa, while maintenance cost and machine tool reliability are indicated along the ordinate. The lower curve 70 represents machine tool reliability over time, and the upper curve 72 represents maintenance cost over time. Ordinarily, it is desirable to take measures to extend machine tool life as long as possible in order to avoid the cost of a new machine. This may require periodic maintenance. While one could choose to wait until a machine tool component fails before performing maintenance, productivity and cost factors militate against this strategy. Accordingly, preventive maintenance may be a better choice. However, various factors affect the cost of preventive maintenance.

Viewing curve 72 in FIG. 4, it can be seen that maintenance costs will be high early in machine tool life. Logically, this is partly because the machine tool is highly reliable (as indicated by curve 70) during this stage. Replacing a reliable component would be an unnecessary cost and would incur unnecessary personnel and resource expense. Waiting until failure or very low machine reliability also may involve high maintenance cost. This may be because machine tool performance may have been significantly below the desired level for a period of time, resulting in lower quality work and higher waste of material. In addition, component failure and/or component performance that is significantly below the desired level may cause damage to other machine components and further increase maintenance costs.

There is an optimum point at which preventive maintenance should be performed in order to hold cost at a minimum while maintaining adequate machine tool reliability. FIG. 4 graphically illustrates this point by arrow 74, directed toward a low point on curve 72 which corresponds to a point along curve 70 where reliability of the component may be less than desired, but still reliable to an extent that failure or work product deterioration has not occurred. Appropriate enterprise resource planning (i.e., ERP) to maintain production and minimize costs may occur where personnel, for a particular machine tool component, are aware of the time when the point represented by arrow 74 occurs. The disclosed system 10 provides for the collection and processing of appropriate sensor data, and enables planning to ensure that preventive maintenance may occur at the optimum point indicated by arrow 74 in FIG. 4. ERP ensures the readiness of an alternate machine during maintenance downtime and early parts ordering thus ensuring against loss of production in a manufacturing process.

### INDUSTRIAL APPLICABILITY

The disclosed system and method for machine tool health early warning monitoring may significantly reduce incidents of machine tool downtime. In addition, the disclosed system and method may enable the proactive implementation of preventative maintenance so that potential and impending machine and production line issues may be corrected before they occur. The disclosed system and method also may provide increased productivity and achievement of lead time planning and optimization. An alternate machine tool may be readied for the production line during maintenance, and spare parts may be ordered early so as to be available during the scheduled maintenance. Delays in a manufacturing process may be avoided and continued production may be ensured.

Machine tool health is a key productivity driver for manufacturing parts. Large structure machining, for example large components employed in manufacturing and assembling large excavating, mining, and haulage machines, is particularly dependent on machine tool health in order to maintain efficient production of parts. It has been found that unexpected spindle mechanism and/or table system failure, adverse conditions of work tool coolant, various overheated machine tool components, and severe tool wear result in substantial rework, machine downtime, and excessive use of personnel resources. The disclosed machine tool health early warning monitoring system and method enable proactive preventive maintenance to become a reliable reality. Another advantage may be increased productivity and planned lead times that keep a production line in operation. Assets may be better utilized, spare parts inventory can be kept low, parts manufacturing can be reliably sustained, and energy use can be optimized.

Sensing vibration in a spindle mechanism and table system for the machine tool via at least one first sensor, sensing a condition of a coolant for a work tool of the machine tool via at least one second sensor, sensing temperature of a machine tool component via at least one third sensor, and sensing tool wear via at least one fourth sensor may generate first, second, third, and fourth data sets to be processed and sent to enterprise resource planning. Via enterprise resource planning, preventive maintenance may be efficiently and effectively scheduled and implemented.

In addition to monitoring vibration of the spindle mechanism and table system, monitoring coolant condition, monitoring component overheating, and monitoring tool wear, other components, conditions, and aspects of machine tools may be monitored. For example, key electric motors may be monitored, the quality of machined parts may be monitored, workpiece clamping systems may be monitored, and chip conveyors may be monitored. All data derived from the various component, condition, and aspect monitoring may be sent to the central data server and included for planning and scheduling machine tool maintenance via enterprise resource planning.

It will be apparent to those skilled in the art that various modifications and variations can be made in the disclosed method and system for machine tool health early warning monitoring without departing from the scope of the disclosure. Other embodiments of the disclosed method and system for machine tool health early warning monitoring will be apparent to those skilled in the art from consideration of the specification. It is intended that the specification and examples be considered as exemplary only, with a true scope of the disclosure being indicated by the following claims and their equivalents.

What is claimed is:

1. A system for monitoring machine tool health, comprising:
a machine tool;
a central data server configured to receive, process, and send data;
a plurality of sensors associated with the machine tool, wherein the sensors are configured to measure operating parameters of the machine tool that relate to potential failure of a machine tool component, and configured to send data relative to the measured operating parameters to the central data server; and
a system for enterprise resource planning configured to receive data from the central data server, analyze the received data to determine whether preventive maintenance is indicated for the machine tool, and schedule preventive maintenance for the machine tool.

2. The system of claim 1, wherein the plurality of sensors associated with the machine tool includes a vibration sensor configured to sense vibrations in a spindle mechanism and table system of the machine tool.

3. The system of claim 2, wherein the plurality of sensors also includes at least one sensor configured to sense at least one of the pH of a coolant, the concentration of a coolant additive, and a level of available coolant for a work tool of the machine tool.

4. The system of claim 3, wherein the plurality of sensors also includes at least one sensor configured to sense the temperature of components of the machine tool.

5. The system of claim 4, wherein the plurality of sensors also includes at least one sensor configured to sense tool wear.

6. The system of claim 5, wherein the central data server is configured to send alerts relevant to preventative maintenance, and including at least one remote viewing station where data in the central data server can be viewed.

7. A method of monitoring machine tool health, comprising:
initially operating the machine tool at a desired performance level;
sensing operating parameters that are indicative of potential failure or less than the desired machine tool performance level for a plurality of components of the machine tool while the machine tool is machining a workpiece;
generating data from sensing the operating parameters;
communicating the data to a central data server;
processing the data and sending the processed data to a system for enterprise resource planning; and
scheduling preventative maintenance for the machine tool, based on the processed data.

8. The method of claim 7, including sensing vibrations in a spindle mechanism and table system of the machine tool.

9. The method of claim 8, including sensing at least one of the pH of a coolant, the concentration of a coolant additive, and a level of available coolant for a work tool of the machine tool.

10. The method of claim 9, including sensing the temperature of components of the machine tool.

11. The method of claim 10, including sensing tool wear.

12. The method of claim 11, including sending alerts to personnel relevant to preventative maintenance for the machine tool.

13. The method of claim 12, including providing access to generated data via one or more remote viewing stations.

14. An early warning system for the health of a plurality of machine tools, comprising:
a plurality of machine tools configured to perform sequential machining operations on a workpiece;
at least one first sensor for sensing vibration in a spindle mechanism and table system for each of the plurality of machine tools;
at least one second sensor for sensing a condition of a coolant for a work tool of each of the plurality of machine tools;
at least one third sensor for sensing temperature of a machine component of each of the plurality of machine tools;
at least one fourth sensor for sensing tool wear in each of the plurality of machine tools;
a central data server for receiving sensor data from each of the first, second, third, and fourth sensors of each of the plurality of machine tools, processing the received sensor data, and sending processed data via at least one of an email early warning alert and a text message early warning alert;
a remote viewing station configured to permit viewing of data processed by the central data server; and
a system for enterprise resource planning configured to receive processed data from the central data server and schedule preventive maintenance for one or more of the plurality of machine tools based on the received processed data, and schedule one or more alternative machine tools to substitute for the one or more of the plurality of machine tools during preventive maintenance.

15. The system of claim 14, wherein each machine tool of the plurality of machine tools is configured to communicate data to other machines of the plurality of machine tools.
